(19) United States
(12) Patent Application Publication
(10) Pub. No.: US 2007/0171942 A1
(43) Pub. Date: Jul. 26, 2007

(54) System and method for conducting fast channel change for IPTV

(75) Inventor: Fabrice M.R. Quinard, Los Gatos, CA (US)

Correspondence Address: THELEN REID BROWN RAYSMAN & STEINER LLP, P. O. BOX 640640, SAN JOSE, CA, 95164-0640, US

(73) Assignee: Terayon Communication Systems, Inc.

(21) Appl. No.: 11/340,258

(22) Filed: Jan. 25, 2006

(51) Int. Cl. H04J 3/00

(52) U.S. Cl. 370/498

(57) ABSTRACT

A system for conducting fast-channel switching of programming delivered as compressed data streams over a unicast channel includes a switch for receiving both fully-compressed and a partially-compressed versions of the data streams corresponding to available programming. Upon receiving a channel change request from a user, the switch switches to a partially compressed data stream of the requested program and delivers this data stream over the unicast channel. The switch then monitors a fully-compressed data stream of the requested program, and upon encountering an anchor frame therein, switches to delivery of the fully-compressed version of the requested program over the unicast channel.

### CROSS-REFERENCE TO RELATED APPLICATIONS

(Not applicable)

### FIELD OF THE INVENTION

The invention relates to telecommunications systems, and more particularly, to cable television systems using data stream compression.

### DESCRIPTION OF THE RELATED ART

It is known in the art to reduce channel change delay due to MPEG compression by reducing the duration between random access points such as I frames. Specifically, according to the well-known MPEG standard, the duration between random access points, or I-frames, which are referred to as anchor frames because they are “free-standing” and can be used as the basis to begin image construction, can be as long as 2 seconds. This means that a decoder that first begins to construct an MPEG-encoded image may introduce a delay of up to 2 seconds or more before the image can be fully reconstructed. A user switching channels will find such a delay frustrating.

To alleviate this problem, upon a channel change request, subscribers can be sent two versions of a programming channel. The first version is the fully-compressed data stream in accordance with the MPEG standard. The second version is one in which I-frames, or random access points, appear more frequently, for example every other frame, reducing the delay before an I-frame is received and reconstruction can begin. Once the image of the second data stream is reconstructed, the subscriber system monitors the fully-compressed data stream, and at the next random access point available in this fully-compressed data stream, the subscriber system seamlessly switches from the second, less-compressed data stream to the fully-compressed data stream. The subscriber system then signals that the switch to the fully-compressed data stream has occurred, indicating that the second, less-compressed version of the data stream no longer needs to be transmitted, in order to conserve transmission resources. This approach works well to reduce channel change delay. However, it requires transmission to the subscriber, at least initially, of both the fully-compressed and second version of the data streams. This is problematic because bandwidth to the subscriber in particular is at a premium and there is a long-felt need to conserve as much of it as possible.

### SUMMARY OF THE INVENTION

In accordance with one aspect of the invention, there is provided a method for reducing channel switch delay on a unicast channel through which programming is transmitted from a switch to a subscriber. The method includes, responsive to a channel change signal, transmitting over the unicast channel a partially-compressed data stream containing anchor frames that are undergoing transmission at a first rate; monitoring a fully-compressed data stream corresponding to the partially-compressed data stream and containing anchor frames that are undergoing transmission at a second rate lower than the first rate; and replacing transmission of the partially-compressed data stream with transmission of the fully-compressed data stream over the unicast channel when an anchor frame is detected in the monitored fully-compressed data stream.

Further in accordance with an aspect of the invention, there is provided a method for enabling fast channel change. The method includes generating for each of a plurality of programs a partially-compressed data stream and a fully-compressed data stream, the partially-compressed data stream containing more anchor frames per time duration than the fully-compressed data stream; transmitting the partially-compressed and fully-compressed data streams to a switch; and, at any given time, transmitting from the switch to a subscriber a single, either fully-compressed or partially compressed data stream.

Further in accordance with an aspect of the invention, there is provided a fast channel change system. The system includes a plurality of encoder pairs, each pair being associated with a program and including first and second encoders respectively generating a fully-compressed data stream and a partially-compressed data stream that are associated with the program, the partially-compressed data stream containing more anchor frames per time duration than the fully-compressed data stream. The system also includes a switch adapted to receive fully-compressed and partially-compressed data streams from a plurality of encoder pairs and to transmit a single data stream in response to a channel change signal.

Further in accordance with an aspect of the invention, there is provided, in a fast channel change system in which, for each of a plurality of programs, a partially- and a fully-compressed data streams are generated, the partially-compressed data stream containing more anchor frames per time duration than the fully-compressed data stream, a switch that includes a switching module and a frame monitor in communication with the switching module. The frame monitor communicates an anchor frame detection signal to the switching module to thereby cause the switch to switch transmission from the switch from a partially-compressed data stream associated with a first program to a fully compressed data stream associated with the first program.

### BRIEF DESCRIPTION OF THE DRAWINGS

Many advantages of the present invention will be apparent to those skilled in the art with a reading of this specification in conjunction with the attached drawings, wherein like reference numerals are applied to like elements, and wherein:

FIG. 1 is an architectural diagram of a fast channel change system 10 in accordance with the invention; and

FIG. 2 is a schematic diagram of a switch in accordance with the invention.

### DETAILED DESCRIPTION OF THE INVENTION

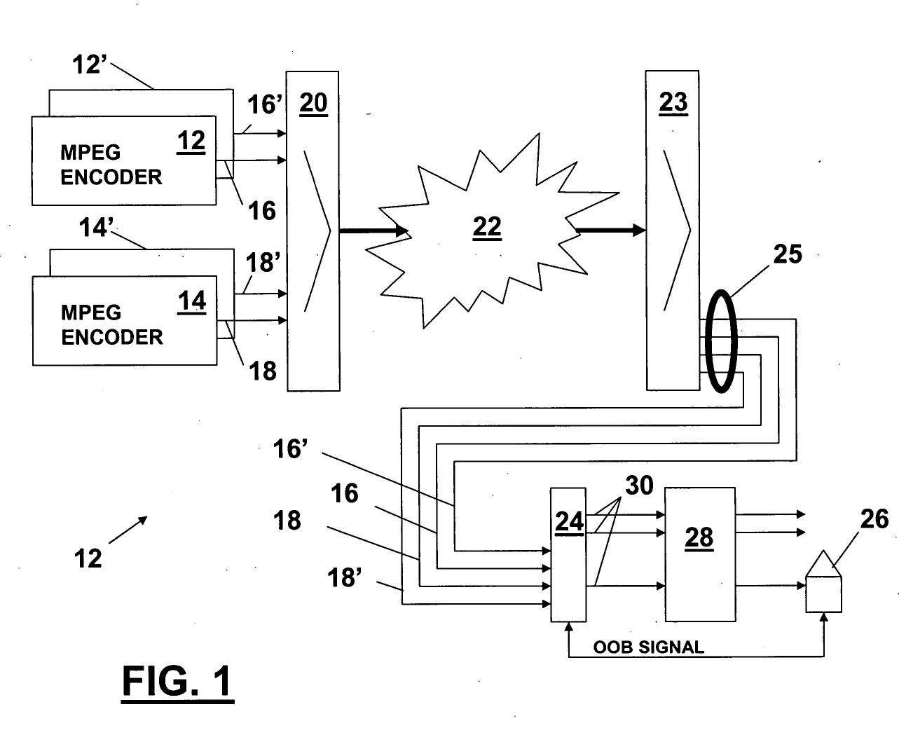

FIG. 1 is an architectural diagram of a fast channel change system 10 in accordance with the invention. First and second encoders 12 and 14 each associated with a particular programming channel provide their output signals 16 and 18 to a combiner 20. Each encoder is designed to encode programming information in accordance with known encoding techniques, in this example the MPEG2 standard, described in further detail below. The output of combiner 20 is directed, through a network 22, which may be for example an inter-office IP distribution ring, to an IP distribution gateway 23 such as an IP over DWDM transport device. The programming information is then transmitted over a local IP network 25. A switch 24 receives the signals and forwards these to individual subscribers 26 by way of a digital subscriber line access multiplexer (DSLAM) 28. The connection between switch 24 and subscribers 26 is a unicast connection 30, discussed in more detail below.

Switch 24 is responsive to channel change requests received over a return, upstream channel from the subscribers 26 as these subscribers make their programming selections. When a selection is made, switch 24 directs the selected program to the subscriber and informs the subscriber of the tuning particulars (channel, frequency, encoding information, IP address, and so forth) required to receive the selected program.

To avoid a delay associated with compression during channel program switches, additional encoders 12′ and 14′ each dedicated to the same programming or data streams as encoders 12 and 14 are provided. It will be recalled that in the MPEG2 compression standard, three types of frames are used. The I-frames are intra-coded—that is, they can be reconstructed without any reference to other frames. The price for this is that they are typically the most information-intensive of the frames and accordingly consume the highest transmission resources. The P-frames are forward-predicted from the last I-frame or P-frame—that is, it is impossible to reconstruct them without the data of another frame (I or P). The B-frames are both forward-predicted and backward-predicted from the last/next I-frame or P-frame—that is, there are two other frames necessary to reconstruct them. P- and B-frames are less dense than I-frames and consume less transmission resources. In this encoding scheme, a typical interval between I frames during playback or decoding is from about 0.5 to 2 seconds or more. I-frames are also referred to as anchor frames and are used as the point of reference here because it is from the I-frames that a newly-tuned channel is initially constructed for viewing, and a subscriber who tunes to the channel must await an I-frame to begin viewing fully reconstructed pictures. Accordingly, in the worst case scenario in which the viewer has tuned to a channel just after the last frame was sent from the DSLAM, the viewer must wait as long as 2 seconds or more before the requested channel makes a fully reconstructed visual appearance, for example on a television set. This 2-second delay can be reduced by employing a less efficient compression structure. For instance, rather than transmitting an I frame every fifteen or so frames, the I-frame transmission rate can be increased so that every other transmitted frame can be made an I-frame. This either increases the amount of information that must be transmitted, or reduces the quality of the compressed information, but it also reduces the delay between I-frames and the consequent reconstruction delay when a channel is newly-tuned to. Programming or data streams subjected to this less efficient compression structure will for convenience be herein referred to as being partially-compressed, to distinguish them from fully-compressed data streams in accordance with standard MPEG2 compression. Of course the invention is not limited to MPEG2 compression, as it is contemplated that it is applicable to other types of compression, such as standard MPEG or MPEG4/AVC. The equivalent of an MPEG2 I-frame in MPEG4/AVC is an IDR (instantaneous decoder refresh) frame. There is a guaranty that the frames following an IDR will not be predicted from frames transmitted before the IDR. So for fast channel change the secondary—that is, partially compressed—stream will be encoded mostly with IDRs and transmitted until the switch can happen to the primary—that is, fully compressed—stream when an IDR is detected.

Returning to FIG. 1, encoders 12′ and 14′ encode the same programming as encoders 12 and 14, respectively, but using the lower compression efficiency structure—for instance, one I-frame every other frame. The partially-compressed signals 16′ and 18′ from encoders 12′ and 14′ are also forwarded to combiner 20, along with the fully-encoded signals 16 and 18 from encoders 12 and 14. They are then transmitted via network 22 to IP distribution gateway 23 to arrive at switch 24 of local IP network 25. In this manner, switch 24 receives partially-compressed (16′) and fully-compressed (16) signals corresponding to a first channel, and partially-compressed (18′) and fully-compressed (18) signals corresponding to a second channel. When a user makes a selection via return channel signaling to switch 24, for example of programming channel 16, the partially-compressed version (16′) characterized by a higher rate of I-frame transmission is sent initially, so that an I-frame is encountered more quickly and the user experiences a pseudo-immediate response to the channel selection. Subsequently, as detailed below, a switch is made to the fully-compressed data stream characterized by the lower rate of I-frame transmission. Importantly, for each newly-selected channel 16, 18, only one compressed signal, which at any given moment may be either the partially-compressed data stream 16′ or 18′ or the fully-compressed data stream 16 or 18, needs to be transmitted to subscriber 26, by way of unicast channel 30. The result is a significant saving in bandwidth dedicated to each subscriber, in contradistinction with proposed systems which transmit to the subscriber both the fully-compressed and less-compressed version of each channel in addressing undesired channel change delay.

Based on the above description, fast-channel change operation in accordance with the invention can be described with reference to the following procedure. As mentioned above, from the switch 24 to the subscribers 26, there is a unique, or unicast connection or stream per subscriber, which in FIG. 1 is designated generally as 30. At a given time during normal operation, that stream 30 for a particular subscriber 26 may be carrying the fully compressed version of one of the programs 16 and 18, for instance program 16. Upon a channel change request from the subscriber 26, for example requesting program 18, the transmission of the fully-compressed version of the program 16 is switched to the transmission of the partially-compressed version of program 18′, which can be performed seamlessly. The transmission of the partially-compressed version of program 18′ continues while switch 24 monitors the fully compressed version of the stream 18. When switch 24 detects the occurrence of an anchor frame or random access point (for example, I-frame) in the fully-compressed version of the stream 18, the switch stops the transmission of the partially compressed stream 18′ and begins the transmission of the fully-compressed stream 18, while ensuring a seamless transition from the partially-compressed stream 18′ to the fully-compressed stream 18. This switched transmission, conducted over unicast channel 30 which needed to contain only one data stream at any given time, achieves a significant bandwidth savings.

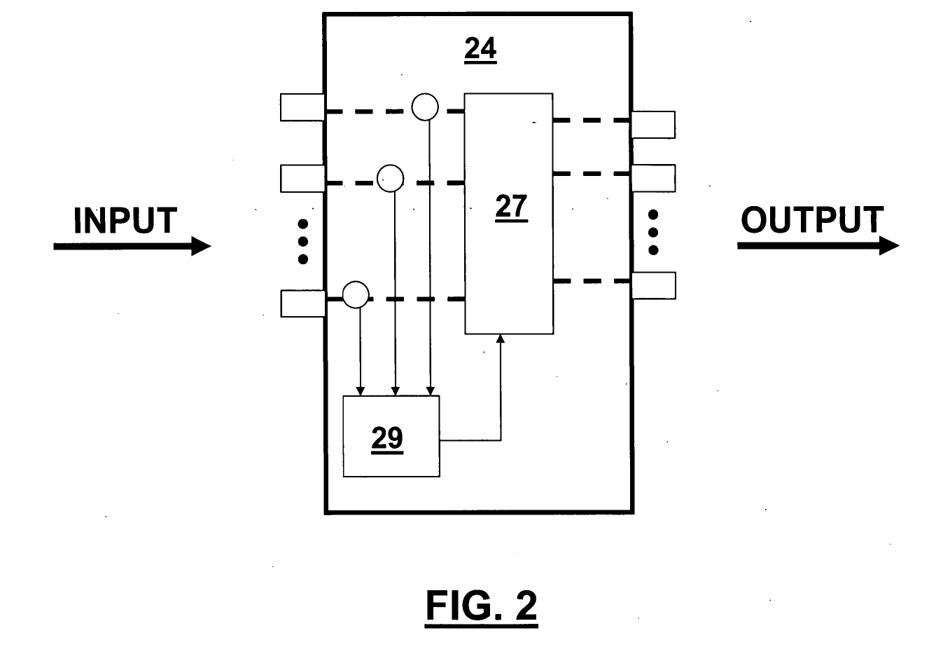

FIG. 2 provides a more detailed high-level view of switch 24. Incoming transmissions comprising partially- and fully-compressed data streams are received at the input (left-hand) side of the schematic representation of switch 24, and selectively transmitted at the output (right-hand) side. A switching module 27 controls the selective switching, based on the output of a frame monitor 29 which communicates a signal to the switching module indicative of an anchor frame detected by the frame monitor.

The above are exemplary modes of carrying out the invention and are not intended to be limiting. It will be apparent to those of ordinary skill in the art that modifications thereto can be made without departure from the spirit and scope of the invention as set forth in the following claims.

1. A method for reducing channel switch delay on a unicast channel through which programming is transmitted from a switch to a subscriber, comprising:
responsive to a channel change signal, transmitting over the unicast channel a partially-compressed data stream containing anchor frames that are undergoing transmission at a first rate;
monitoring a fully-compressed data stream corresponding to the partially-compressed data stream and containing anchor frames that are undergoing transmission at a second rate lower than the first rate; and
replacing transmission of the partially-compressed data stream with transmission of the fully-compressed data stream over the unicast channel when an anchor frame is detected in the monitored fully-compressed data stream.

2. The method of claim 1, wherein the partially-compressed and fully-compressed data streams correspond to a first program, the method further comprising, prior to transmitting the partially-compressed data stream corresponding to the first program, transmitting over the unicast channel a fully-compressed data stream corresponding to a second program.

3. The method of claim 1, wherein the anchor frames are MPEG2 I-frames.

4. The method of claim 1, wherein the anchor frames are MPEG4 IDR frames.

5. A method for enabling fast channel change comprising:
generating for each of a plurality of programs a partially-compressed data stream and a fully-compressed data stream, the partially-compressed data stream containing more anchor frames per time duration than the fully-compressed data stream;
transmitting the partially-compressed and fully-compressed data streams to a switch; and
at any given time and for any given program, transmitting from the switch to a particular subscriber a single, either fully-compressed or partially compressed data stream.

6. The method of claim 5, further comprising:
causing the switch to switch transmission to the particular subscriber from a fully-compressed data stream associated with a first program to a partially-compressed data stream associated with a second program.

7. The method of claim 6, further comprising monitoring a fully-compressed data stream associated with the second program, and switching transmission to the particular subscriber to the fully-compressed data stream associated with the second program when an anchor frame in the fully-compressed data stream associated with the second program is reached.

8. The method of claim 6, wherein the transmission switch from the fully-compressed to the partially-compressed data streams is in response to a channel change request from the particular subscriber.

9. The method of claim 5, wherein the anchor frames are MPEG2 I-frames.

10. The method of claim 7, wherein the anchor frames are MPEG2 I-frames.

11. The method of claim 5, wherein the anchor frames are MPEG4 IDR frames.

12. The method of claim 7, wherein the anchor frames are MPEG4 IDR frames.

13. A fast channel change system comprising:
a plurality of encoder pairs, each pair being associated with a program and including first and second encoders respectively generating a fully-compressed data stream and a partially-compressed data stream that are associated with the program, the partially-compressed data stream containing more anchor frames per time duration than the fully-compressed data stream; and
a switch adapted to receive fully-compressed and partially-compressed data streams from a plurality of encoder pairs and to transmit, at any given time to a particular subscriber, either a fully-compressed or partially-compressed data stream in response to a channel change signal.

14. The system of claim 13, wherein the switch contains a switching module that causes switching of transmission from the switch from a fully-compressed data stream of a first program to a partially-compressed data stream of a second program.

15. The system of claim 14, wherein the switch includes a frame monitor adapted to detect an anchor frame in a fully-compressed data stream of the second program and to generate an anchor frame detection signal.

16. The system of claim 15, wherein the switching module causes switching of transmission from the switch from the partially-compressed data stream of the second program to a fully-compressed data stream of the second program in response to the anchor frame detection signal.

17. The system of claim 13, wherein the anchor frames are MPEG2 I-frames.

18. The system of claim 15, wherein the anchor frame detected by the frame monitor is an MPEG2 I-frame.

19. The system of claim 13, wherein the anchor frames are MPEG4 IDR frames.

20. The system of claim 15, wherein the anchor frames are MPEG4 IDR frames.

21. The system of claim 13, wherein the switch comprises:
a switching module; and
a frame monitor in communication with the switching module, the frame monitor communicating an anchor frame detection signal to the switching module to thereby cause the switch to switch transmission from the switch from a partially-compressed data stream of a first program to a fully compressed data stream of the first program.

22. In a fast channel change system in which, for each of a plurality of programs, a partially- and a fully-compressed data stream is generated, the partially-compressed data stream containing more anchor frames per time duration than the fully-compressed data stream, a switch comprising:
a switching module; and
a frame monitor in communication with the switching module, the frame monitor communicating an anchor frame detection signal to the switching module to thereby cause the switching module to switch transmission from the switch from a partially-compressed data stream associated with a first program to a fully compressed data stream associated with the first program.

23. The switch of claim 22, wherein the anchor frames are MPEG I-frames.

24. The switch of claim 22, wherein the anchor frames are MPEG4 IDR frames.
